(19) United States
(12) Patent Application Publication
(10) Pub. No.: US 2006/0149962 A1
(43) Pub. Date: Jul. 6, 2006

(54) Network attached encryption

(75) Inventors: Thomas Fountain, Redwood City, CA (US); Alan Frindell, Mountain View, CA (US)

Correspondence Address: PERKINS COIE LLP, P.O. BOX 2168, MENLO PARK, CA, 94026, US

(73) Assignee: Ingrian Networks, Inc., Redwood City, CA (US)

(21) Appl. No.: 10/519,239

(22) PCT Filed: Jul. 11, 2003
(86) PCT No.: PCT/US03/21695

§ 371 Date: Jan. 23, 2006

(51) Int. Cl. H04L 9/00; H04L 9/32; G06F 15/16; G06F 17/30; G06F 7/04; G06F 7/58; G06K 19/00; G06K 9/00

(52) U.S. Cl. 713/151; 726/3

(57) ABSTRACT

A method and apparatus are provided for managing cryptographic keys and performing cryptographic services within server or other computing environments. An appliance functions as a cryptographic key server to secure cryptographic keys and provide cryptographic operations as a network service.

### TECHNICAL FIELD

The present invention relates generally to the field of data security, and more particularly to providing cryptographic network services and securing cryptographic keys in a network environment.

### BACKGROUND

Computer systems dealing with sensitive content strive to protect this secure content both during network transmission and localized storage. For example, e-commerce web sites use a variety of mechanisms to protect user credit card numbers and user passwords during transmission. Often these sites use the well-known Secure Socket Layer (SSL) or Transport Layer Security (TLS) protocols to protect all sensitive data during transit between customer computers and web sites.

SSL and TLS protect data while in transit by encrypting the data using a session-key, (i.e., a cryptographic key), known only to the web server and the client computer. According to these protocols, the data is decrypted upon arrival at the receiving web server. The receiving server processes the data (e.g., validating the credit card number) and then often stores the sensitive data in a server database.

The cryptographic keys that are used to set up the SSL connection between Web clients and internal Web servers are stored in the same internal Web servers. Similarly, when encryption is performed on data to be stored on back-end application servers and databases, the cryptographic keys are stored in the same back-end application servers, which are usually unsecured platforms. Thus, cryptographic keys that are stored on the same web server or back-end application server are vulnerable to theft. The encrypted data are only as safe as the cryptographic keys that protect the encrypted data.

Web Servers and applications servers, on which cryptographic operations are directly performed, suffer from poor performance due to the processing requirements of the cryptographic operations. In one approach, expensive hardware such as cryptographic accelerator cards are used on such servers to improve performance of the servers. However, it is cost prohibitive to install expensive cryptographic accelerators on each Web/application server.

A different architecture is needed to protect cryptographic keys as well as improve performance of cryptographic operations without installing expensive cryptographic accelerators on each Web/application server that needs cryptographic services.

### BRIEF DESCRIPTION OF THE FIGURES

The accompanying figures illustrate embodiments of the claimed invention. In the figures:

FIG. 1 illustrates a computer server environment 10 providing networked cryptographic services in accordance with one embodiment of the present invention;

FIG. 2 diagrammatically illustrates a software architecture in accordance with one embodiment of the present invention;

FIG. 3A illustrates a hardware architecture suitable for a networked cryptographic key server in accordance with one embodiment of the present invention;

FIG. 3B illustrates an operation 150 for backup and restoring of the private keys with respect to a cryptographic server that supports k-out-of-n secret sharing of the group key in accordance with certain embodiments of the present invention;

FIG. 4 is a flowchart that illustrates a computer-implemented method by which a networked cryptographic key server may provide cryptographic services in accordance with one embodiment of the present invention;

FIG. 5 is a flowchart that illustrates a computer-implemented method for performing authentication and authorization analysis of a cryptographic request in accordance with one aspect of the present invention;

FIG. 6 is a flowchart that illustrates a computer-implemented method for enabling applications instantiated on an application server to access remote and local cryptographic services through a standard cryptographic API;

FIG. 7 illustrates a distributed cryptographic services computing environment in accordance with certain embodiments of the present invention;

FIG. 8 is a block diagram that illustrates a system architecture in which a network security appliance provides networked cryptographic key services in accordance with certain embodiments of the invention; and

FIG. 9 is a block diagram that illustrates a network architecture including a transparent encryption network security appliance and a cryptographic key server.

In the drawings, the same reference numbers identify identical or substantially similar elements or acts. Any headings used herein are for convenience only and do not affect the scope or meaning of the claimed invention.

### DETAILED DESCRIPTION OF THE ILLUSTRATED EMBODIMENTS

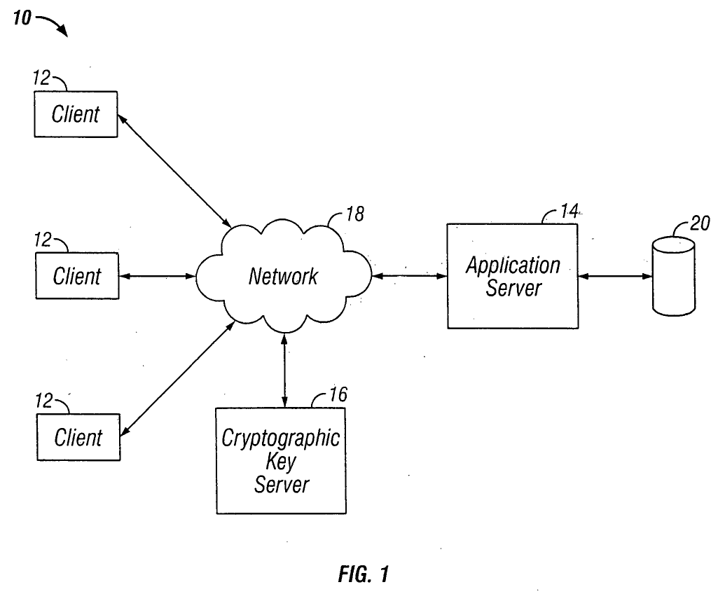

FIG. 1 illustrates a computer server environment 10 providing networked cryptographic services in accordance with one embodiment of the present invention. The computer server environment 10 includes a plurality of clients 12, an application server 14, and a cryptographic key server 16, all bi-directionally coupled via a computer network 18. The computer network 18 may take the form of any suitable network such as the Internet or a local area network. Bi-directionally coupled to the application server 14 is a network database 20. The application server 14 provides requested services to the clients 12 via the computer network 18. Services requested by the clients 12 may specifically involve cryptographic services, or may precipitate the need for cryptographic services. For example, the client requested services may require the storage of sensitive data on the network database 20, or the retrieval of encrypted data from the network database 20. The cryptographic key server 16 is available to the application server 14 to perform cryptographic services, thus offloading the computational intensities of cryptographic services from the application server 14.

The cryptographic key server referred to herein is also known as a Networked Attached Encryption device. The nature of the cryptographic services as well as a variety of mechanisms implementing such functionality are described below in more detail.

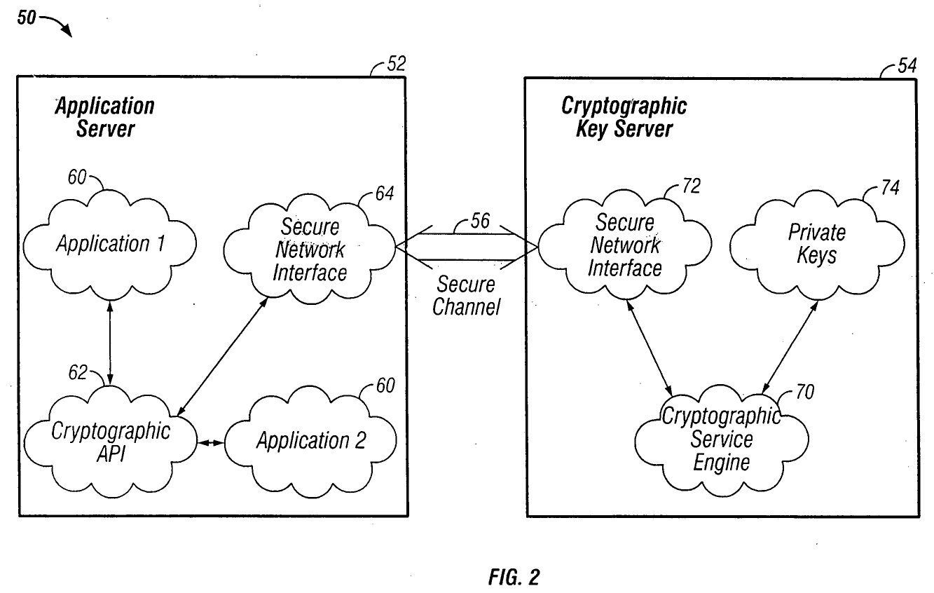

FIG. 2 diagrammatically illustrates a software architecture 50 for an application server 52 and a cryptographic key server 54 in accordance with one embodiment of the present invention. The software architecture of FIG. 2 is not limited to application servers and may vary from implementation to implementation. Any number of computer devices and systems may be a client of cryptographic key server 54. In preferred embodiments, the application server 52 and the cryptographic key server 54 are bi-directionally coupled via a secure network communications channel 56. The secure network communications channel 56 may be effectuated through any suitable secure communications technique such as the secure communications protocols SSL or TLS. Alternatively, a secure channel may be effectuated via a direct physical link or by any means known to those skilled in the art. Software-based application server 52 is only one example of a client that needs the cryptographic services of a cryptographic key server.

The application server 52 of FIG. 2 includes a plurality of applications 60, a cryptographic application program interface (API) 62, and a secure network interface engine 64. The applications 60 are software programs instantiated and executing on the application server 52. These applications 60 may provide services to local users of the application server 52, and may provide network services to remote clients via a network connection.

The cryptographic API 62 provides a set of standards by which the plurality of applications 60 can invoke a plurality of cryptographic services. According to the present invention, at least one of this plurality of cryptographic services is performed remotely by the cryptographic key server 54. To effectuate networked cryptographic key services, the cryptographic API 62 is responsive to a request for a remote cryptographic service to utilize the secure network interface engine 64 to request the cryptographic services.

The cryptographic API 62 is preferably a standardized software cryptographic API which applications developers can easily integrate into their software. Thus, the cryptographic API 62 would take on a specific form relating to the underlying computing environment. Several examples of underlying computing environments include Java, Microsoft, PKCS #11/Cryptoki Provider, Oracle9i, etc, some of which are described in more detail immediately below.

In a Java computing environment, the cryptographic API 62 could be exposed to applications as Java Cryptography Extensions (JCE). The JCE could be used or invoked by a variety of sources, including Java Server Pages (JSP), Java servlets, or Enterprise Java Beans (EJB). Java applications capable of using JCE may also be invoked by Active Server Pages (ASP). In certain other embodiments of the invention, applications 60 may directly access the cryptographic key server 54 without the aid of cryptographic API 62.

In ASP computing environments, such as the Microsoft's NET, the cryptographic functionality may be exposed, e.g., using VBScript, via a Crypto Service Provider (CSP) that VBScript communicates with using Microsoft Cryptographic API (MS-CAPI). In this case, the CSP or cryptographic API would be implemented as a Dynamic Linked Library that exposes a number of cryptographic operations to the applications 60. The foregoing descriptions of the cryptographic functionality and cryptographic API are in the context of web application servers. However, the cryptographic functionality and cryptographic API are equally applicable for application servers that are non-web-based, such as non-web-based Java applications using JCE and non-web-based Windows applications invoking MS-CAPI, etc.

The secure network interface engine 64 is operable to establish the secure network communications channel 56 with the remote cryptographic key server 54. Similarly, the remote cryptographic key server 54 is operable to establish the secure network communications channel 56 with the secure network interface engine 64. After the secure network communications channel 56 is established between the application server 52 and the remote cryptographic key server 54, the secure network interface engine is operable, for example, to marshal and transmit secure requests for cryptographic services to the remote cryptographic key server 54, receive and unmarshal secure responses to requests for cryptographic services, and forward such response back to the cryptographic API 62. In turn, the cryptographic API 62 provides a response to the requesting application 60.

It is contemplated that the secure network interface engine 64 could expose secure network services to the applications 60 for use in providing secure communications channels between the applications 60 and clients of the application server 52. In FIG. 2, the cryptographic API 62 and the secure network interface engine 64 appear as two distinct processes, each instantiated on the application server 52. This allows separate modification of each of these processes. However, another embodiment of the present invention teaches that the functionality of the cryptographic API 62 and the secure network interface engine 64 are provided as a single process or are included in an application 60.

With further reference to FIG. 2, the cryptographic key server 54 includes a cryptographic service engine 70, a secure network interface engine 72, and a private key engine 74. The cryptographic key server 54 is suitable for providing cryptographic services to the application server 52 coupled to said cryptographic key server via the secure network communications channel 56. The secure network interface engine 72 is operable to establish the secure network communications channel 56 with the application server 52. Similarly, the application server 52 is operable to establish the secure network communications channel 56 with the secure network interface engine 72. Further, the secure network interface engine 72 is operable to unmarshal secured cryptographic service requests received from the application server 52, and marshal and transmit secure cryptographic service responses to the application server 52.

The cryptographic service engine 70 executing on the cryptographic key server 54 is bi-directionally coupled with the secure network interface engine 72. The cryptographic service engine 70 is operable to provide cryptographic services requested by the application server 52 via the secure network interface engine 72. Cryptographic services may include: 1) hashing operations, and 2) signing and verification operations such as RSA and DSA.

The cryptographic functions exposed to the applications 60 would include those most likely desired by the remote clients. These cryptographic functions must be performed either at the application server 52, or more preferably at the cryptographic key server 54 in order to offload from the application server 52 the burden of performing cryptographic services. Thus, it is preferred that the cryptographic service engine 70 be capable of performing any exposed cryptographic services not provided at the application server 52. Typical exposed functionality would include, but is not limited to, functions such as encryption and decryption (e.g. DES, 3DES, AES, RSA, DSA, ECC, etc.), signing and verification (e.g. RSA, DSA, etc.), and hashing and verification (e.g. SHA-1, HMAC, etc.). Generally, encryption and decryption functions include:
symmetric block ciphers,
generic cipher modes,
stream cipher modes,
public-key cryptography,
padding schemes for public-key systems,
key agreement schemes,
elliptic curve cryptography,
one-way hash functions,
message authentication codes,
cipher constructions based on hash functions,
pseudo random number generators,
password based key derivation functions,
Shamir's secret sharing scheme and Rabin's information dispersal algorithm (IDA),
DEFLATE (RFC 1951) compression/decompression with gzip (RFC 1952) and zlib (RFC 1950) format support,
fast multi-precision integer (bignum) and polynomial operations,
finite field arithmetic, including GF(p) and GF(2ⁿ), and
prime number generation and verification.

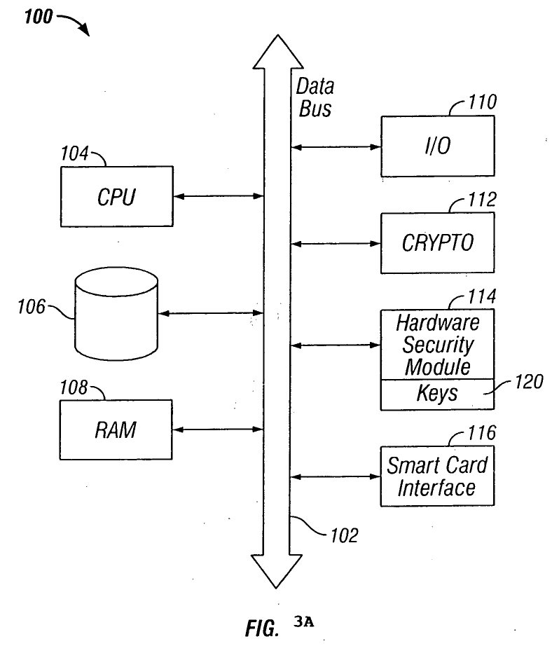

As will be appreciated, the private key engine 74 provides the cryptographic service engine 70 the private keys required for performing cryptographic operations. Such private keys can be generated and stored through a variety of mechanisms known in the art, as well as by several methods contemplated by the present invention. One preferred embodiment for generating and handling the private keys is described below with reference to FIG. 3.

In FIG. 2, the cryptographic service engine 70 and the secure network interface engine 72 appear as two distinct processes each instantiated on the cryptographic service engine 70. This allows separate modification of each of these processes. However, another embodiment of the present invention teaches that the functionality of cryptographic service engine 70 and the secure network interface engine 72 are provided as a single process.

FIG. 3A illustrates a hardware architecture 100 suitable for a networked cryptographic key server such as cryptographic key server 54 of FIG. 2 in accordance with one embodiment of the present invention. The hardware architecture 100 includes a central processing unit (CPU) 104, a persistent storage device 106 such as a hard disk, a transient storage device 108 such as random access memory (RAM), a network I/O device 110, an encryption device 112 such as a cryptographic accelerator card, a hardware security module (HSM) 114, and a smart card interface 116, all bi-directionally coupled via a databus 102. Other additional components may be part of the hardware architecture 100.

According to one embodiment of FIG. 3A, the private keys 120 are loaded into HSM 114 and stored in an encrypted format. In preferred embodiments, the HSM 114 is a tamper resistant device. The private keys 120 are encrypted using a group key known only to a small, predefined group of cryptographic key servers. These group keys are protected by smart cards. When a backup operation is performed on one member of the predefined group of cryptographic servers, an encrypted form of the original cryptographic key is created as a backup file. Only cryptographic servers that are part of the predefined group of devices are able to decrypt the encrypted key using a separate cryptographic key.

In one embodiment, the cryptographic server also supports k-out-of-n secret sharing of the group key for increased security. This means that the cryptographic server requires smart cards for backup and restoring of the private keys. For example, if the group key information is distributed across a group of five smart cards (n), preferences can be set so that group data can be accessed only after inserting three smart cards (k) into the smart card reader 116. Any attempt to access the data with less than three smart cards will fail. Using a k of n schema ensures data safety; if a single card is stolen, the thief will not be able to access the configuration data stored on the HSM 114 because the thief does not have enough cards to meet the k of n criteria set forth above. According to certain embodiments, FIG. 3B illustrates an operation 150 for backup and restoring of the private keys with respect to a cryptographic server that supports k-out-of-n secret sharing of the group key. In step 152, a request for backup and restoring of the private keys is received. At step 154, in response to the request for backup, it is determined whether at least k-out-of-n smart cards has been inserted is a smart card interface device associated with cryptographic server at which the request for backup was made. If it is determined that at least k-out-of-n smart cards has not been inserted, then at step 156, the request for backup and restoring is denied. If it is determined that at least k-out-of-n smart cards has been inserted, then at step 158, the request for backup and restoring is granted.

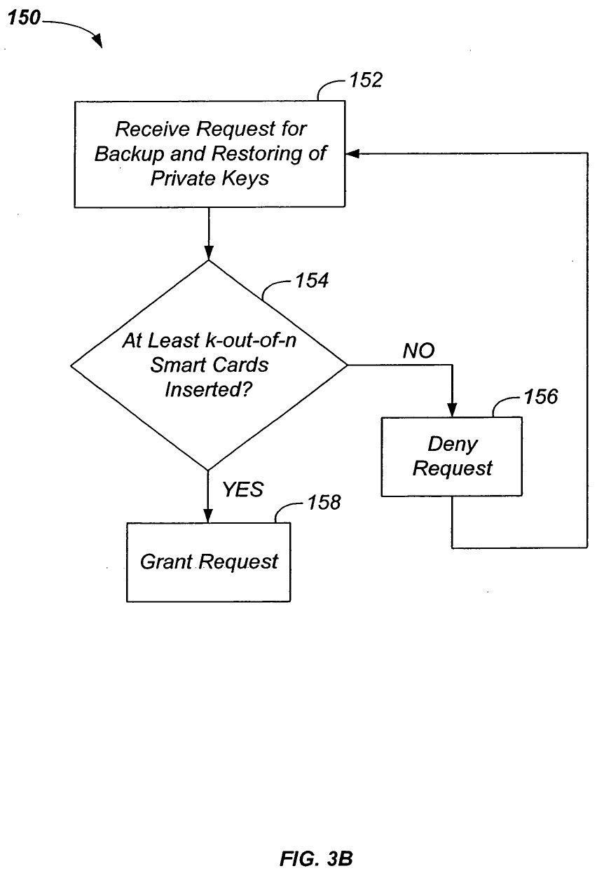

With reference to FIG. 4, a computer-implemented method 200 by which a networked cryptographic key server such as cryptographic key server 16 or 54 may provide cryptographic services in accordance with one embodiment of the present invention will now be described. In an initial step 202, a set of private keys is established on the networked key server. These private keys may be generated and maintained according to any suitable mechanism. In preferred embodiments, the private keys are stored within a tamper-resistant hardware device and are not distributed across the network, but rather are managed through a process such as that described above with reference to the HSM 114 of FIG. 3. Subsequent requests for cryptographic services by a given application server for which a set of private keys is already established on the networked key server do not involve step 202.

In a next initial step 204, a secure network communications channel is established between the application server and the cryptographic key server. In certain embodiments, a connection pool is established between the application server and the key server prior to the client's request of any specific cryptographic services. The connection pool can be maintained indefinitely or may be closed due to inactivity. Establishing a secure connection is processing intensive, so once the secure connection is established it is efficient to maintain the secure connection. The secure channel may be established with SSL or TLS, or any suitable method known in the art. In many situations, HTTPS with server and client certificates might be used. Further, at step 204, the identity of the requesting entity is verified, i.e., authenticated. This may include verification of the application server identity, verification of the identity of the application executing on the application server, and identification of the client requesting services of the application server, if appropriate. If the authentication of the requesting entity fails, then the request for cryptographic services is denied. Further, in certain embodiments, when the authentication of the requesting entity fails, process control passes to step 216 performs housekeeping functions related to a failed request for services as explained below.

Once the private keys have been established in step 202, and a secure network communications channel has been established in step 204 and the authentication process is complete, the cryptographic key server may be used to provide cryptographic services. Accordingly, in a step 206 the key server receives a request for cryptographic services via the secure channel. In receiving the cryptographic service request, the key server will unmarshal the request from encrypted network format. As described above with reference to FIG. 2, in certain embodiments this may be performed by a secure network interface engine. In a step 208, the key server will perform an authorization analysis of the cryptographic service request. The authorization analysis of step 208 determines whether the requested services should be provided to the requesting client. One embodiment of step 208 is described below in more detail with reference to FIG. 4.

When step 208 determines that the request may be performed, process control flows from step 208 to a step 210 that performs the requested cryptographic services. For example, the application server may be requesting that certain data be encrypted or decrypted. In a step 212, the cryptographic key server will respond to the application server via the secure channel. This includes marshalling the data into secure format for transmission across the network. In a next step 214, a variety of housekeeping functions related to satisfaction of an authorized request are performed. In certain embodiments, these include maintaining a database related to cryptographic requests (time, client identity, service requested, satisfactory completion, etc.)

When step 208 determines that the request may not be performed for failure of the authorization step 208, a step 216 performs housekeeping functions related to a failed request for services. In certain embodiments, this includes include maintaining a database related to cryptographic requests (time, client identity, service requested, etc.). This database can be used to evaluate whether an attack is being made, or to determine errors in the system.

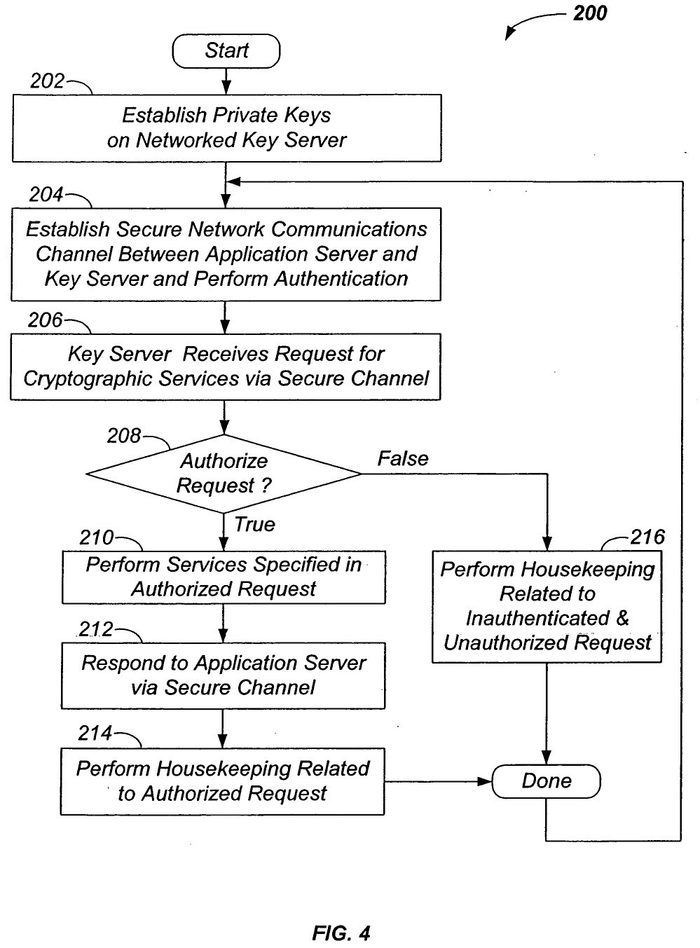

Turning next to FIG. 5, a computer-implemented method 208 for performing authorization analysis of a cryptographic request in accordance with one aspect of the present invention will now be described in more detail. As described above with reference to FIG. 4, the method 208 is invoked when a remote application server requests that a cryptographic key server perform certain cryptographic functions for the application server, likely on behalf of a client of the application server. In a first step 250, the authorization privileges granted to the application server, the application, and the client are determined. If the authorization privileges granted to the application server, the application, and the client cannot be determined, then the authorization test of step 250 is deemed to have failed. When the authorization test of step 250 fails, then the request is denied in a step 252. When the authorization test of step 252 succeeds, then a step 254 determines whether the specific request is within the rights of the requesting entity. For example, a certain application running on the application server may not be entitled to decrypt certain data, or simply may not be entitled to decrypt data whatsoever, even though that same application may be entitled to encrypt data. In any event, when the request is not within the rights of the requesting entity, the request is denied in step 252. When the request is within the rights of the requesting entity, the request is approved in a step 256 and process control proceeds to implement the requested cryptographic services.

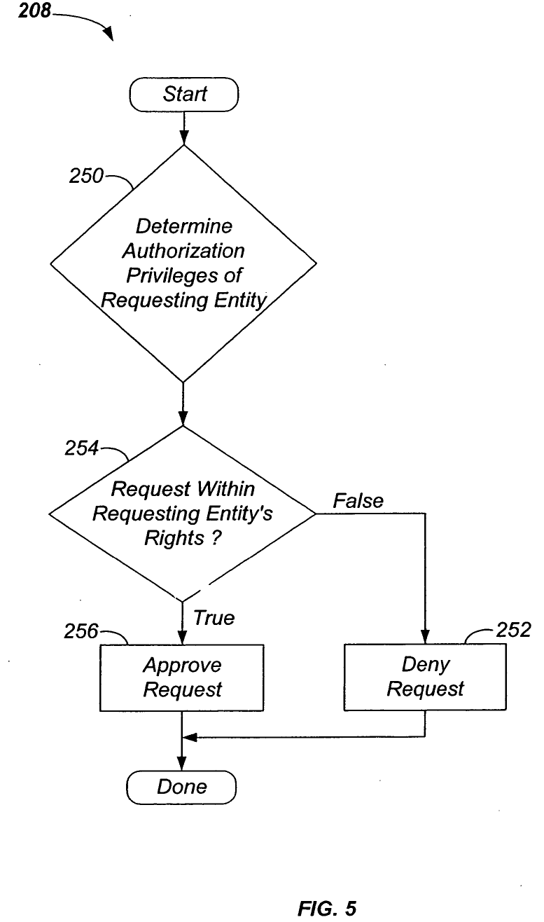

With reference to FIG. 6, a computer-implemented method 300 for enabling applications instantiated on an application server to access remote and local cryptographic services through a standard cryptographic API will now be described. Steps 302 and 304 are initialization steps to make the cryptographic services available to applications. In a step 302, a standardized software cryptographic API is integrated within the application server. As discussed above in more detail with reference to FIG. 2, the cryptographic API can be designed for the specific computing environment (Java, Microsoft, etc.) of the application server. In a step 304, the cryptographic services are exposed to an application instantiated on the application server so that service requests may be made within executing applications. Cryptographic providers allow programmers to develop application software utilizing standard cryptography made available by the cryptographic API.

In a step 306, an application calls a cryptographic function and the cryptographic API receives this request for service. This request is processed by the cryptographic API to determine whether the request should be passed along to the remote cryptographic server, or performed locally or perhaps the application server performs some authentication and authorization locally prior to allowing a request for cryptographic services to be passed along. When the request is to be transmitted to a remote cryptographic server, a step 308 attends to marshalling and transmitting the request. In preferred embodiments, the marshalling and transmission is performed by a secure network interface engine via a previously established secure network transmission channel. In a step 310, the application server receives and unmarshals a response to a cryptographic service request. In preferred embodiments, the receipt and unmarshalling of responses is performed by a secure network interface engine via a previously established secure network transmission channel. The response is provided to the cryptographic API and in a step 312, the cryptographic API provides a response to the requesting application in a suitable format.

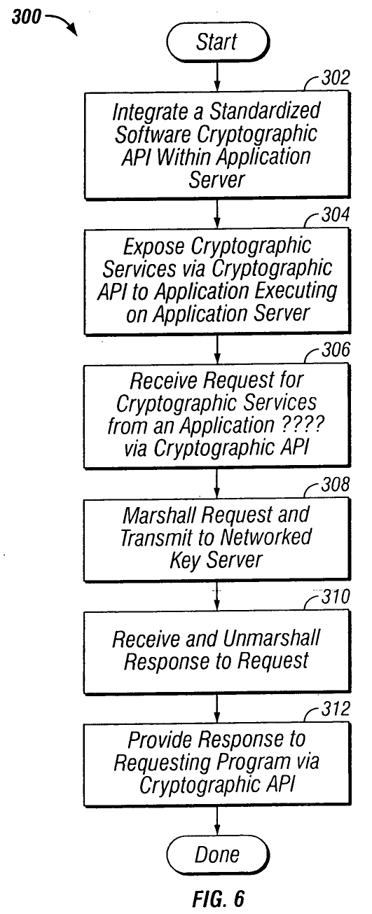

FIG. 7 illustrates a distributed cryptographic services computing environment 400 in accordance with certain embodiments of the present invention. The computing environment 400 includes a plurality of cryptographic key servers 402, a plurality of application servers 404, and a plurality of clients 406, all bi-directionally coupled with a wide area network 408 such as the Internet. The cryptographic key servers 402 and application servers 404 may take any suitable form. For example, the embodiments described above with reference to FIGS. 1-3 would be suitable.

A variety of ways for implementing operation of the distributed cryptographic services computing environment 400 are contemplated. For example, the plurality of cryptographic key servers 402 may operate in an independent fashion, each providing services in an independent fashion. Alternatively, a specific cryptographic key server 402 could act as a manager of all services, directing all requests from the application servers 404 to the other cryptographic key servers 402 based on a predetermined load balancing scheme.

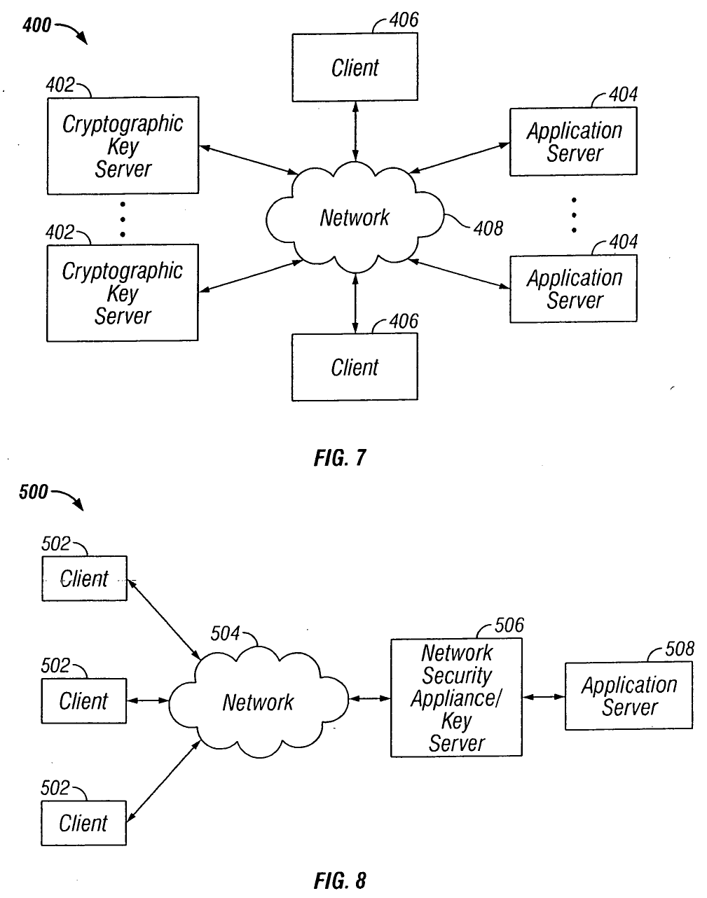

FIG. 8 shows a block diagram of a system architecture 500 in which a network security appliance provides networked cryptographic key services. The system architecture 500 includes a plurality of clients 502, a wide area network 504 such as the Internet, a network security appliance 506, and an application server 508. With the exception of the network security appliance 506, all other elements of FIG. 8 will be readily understood by referring to the above description of FIGS. 1-7.

The network security appliance 506 physically resides between the application server 508 and the network 504. Those skilled in the art will be familiar with network security appliances and their general operation. Some of the services which may be provided by the network security appliance 506 include secure transmission between the clients 502 and the application server 508, secure caching reducing strain upon the application server 508 and improving response time to users, SSL and TLS acceleration, transparent encryption services, client authentication, etc. According to the embodiment of FIG. 8, the network security appliance 506 further provides cryptographic key services to the application server 508. The network security appliance 506 may have a software architecture as described above with reference to cryptographic key server 54 of FIG. 2. Likewise, the network security appliance 506 may have a hardware architecture 100 as described above with reference to cryptographic key server of FIG. 3. The methods described above with reference to FIGS. 4-6 may well apply to the operation of the network security appliance 506 and the application server 508.

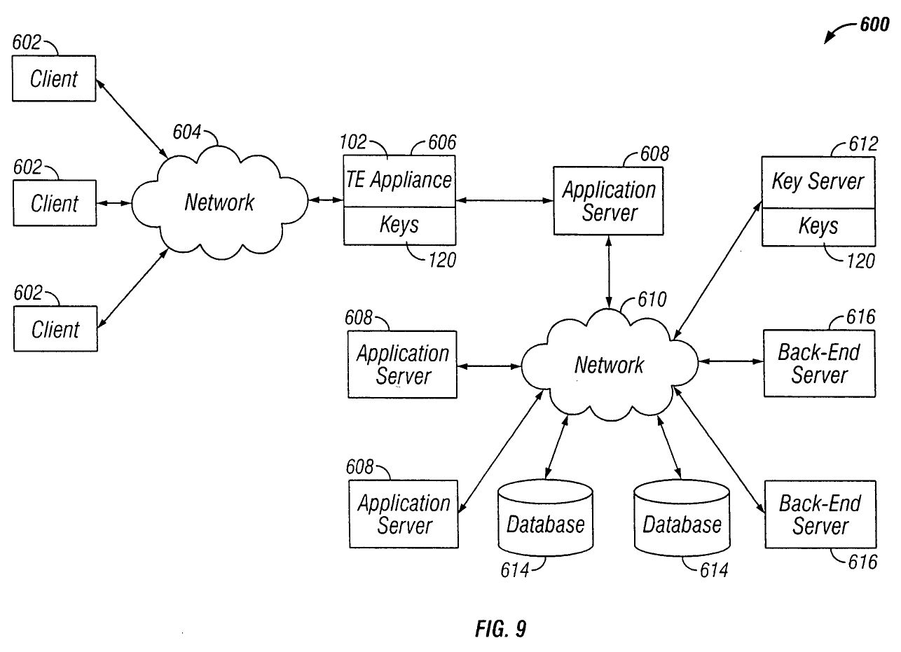

FIG. 9 is a block diagram that illustrates a network architecture 600 including a plurality of clients 602, a wide area network 604 such as the Internet, a transparent encryption appliance 606, a plurality of application servers 608, a local area network 610, at least one cryptographic key server 612, two or more network databases 614, and a plurality of back-end servers 616. As described in related patent applications, the transparent encryption appliance 606 is configured to inspect all requests entering the site via the network 604, and encrypts sensitive data using one of the installed private keys 120. The transparent encryption appliance 606 and the cryptographic key server 612 are both members of a predefined group of TE Appliances that share a group key, and are loaded with the same private keys 120. Multiple application servers 608 are able to request cryptographic services from the cryptographic key server 612, as are back-end servers 616, via the local area network 610.

For purposes of illustration, assume that client 602 registers with a financial institution over the Internet. In this example, application server 608 is a web server, and the client 602 provides a credit card number to web server 608 over the network 604 via a secure session. TE Appliance 606 detects that the credit card number is sensitive information and encrypts this data using one of the installed private keys 120, so that web server 608 does not manage the sensitive information in the clear. Similarly, the credit card number is stored in network database 614 only in encrypted form. Back-end server 616 needs to access the client credit card number to retrieve account information, and make a request to cryptographic key server 612 to decrypt the credit card number. In this example, back-end server 616 is authorized to access the client credit card number, and therefore cryptographic key server 612 decrypts the credit card number as requested.

The figures and the discussion herein provide a brief, general description of a suitable computing environment in which aspects of the invention can be implemented. Although not required, embodiments of the invention are described in the general context of computer-executable instructions, such as routines executed by a general-purpose computer (e.g., a server or personal computer). Those skilled in the relevant art will appreciate that aspects of the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like.

Aspects of the invention can be embodied in a special purpose computer or data processor that is specifically programmed, configured or constructed to perform one or more of the computer-executable instructions explained in detail below. Indeed, the term “computer,” as used generally herein, refers to any of the above devices, as well as any data processor. Further, the term “processor” as generally used herein refers to any logic processing unit, such as one or more central processing units (CPUs), digital signal processors (DSPs), application-specific integrated circuits (ASIC), etc.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any express definitions set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

All of the references and U.S. patents and applications referenced herein are incorporated herein by reference. Aspects of the invention can be modified, if necessary, to employ the systems, functions and concepts of the various patents and applications described herein to provide yet further embodiments of the invention. These and other changes can be made to the invention in light of the detailed description herein.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

We claim:

1. A cryptographic key server suitable for providing cryptographic services to remote devices coupled to said cryptographic key server via a network, said cryptographic key server comprising:
a secure network interface engine executing on said cryptographic key server, said secure network interface engine operable:
to establish a secure network communication channel with at least one remote device;
to unmarshal secured cryptographic service requests received from said at least one remote device; and
to marshal and transmit secure cryptographic service responses to said at least one remote device; and
a cryptographic service engine executing on said cryptographic key server, said cryptographic service engine being in bi-directional communication with said secure network interface engine, said cryptographic service engine operable to provide cryptographic services requested by said at least one remote device via said secure network interface engine.

2. The cryptographic key server as recited in claim 1, wherein said at least one device is an application server.

3. The cryptographic key server as recited in claim 1, wherein said secure network interface engine is arranged such that said secure network communication channel is established according to a Secure Socket Layer (SSL) protocol.

4. The cryptographic key server as recited in claim 1, wherein said secure network interface engine is arranged such that said secure network communication channel is established according to a Transport Layer Security (TLS) protocol.

5. The cryptographic key server as recited in claim 1, wherein said secure network interface engine supports multiple communications protocols including a Secure Socket Layer (SSL) protocol and a Transport Layer Security (TLS) protocol, said secure network interface engine being responsive to said at least one device to establish said secure network communication channel according to a protocol selected by said at least one device.

6. The cryptographic key server as recited in claim 1, wherein said cryptographic service engine and said secure network interface engine are components of a single process executing on said cryptographic key server.

7. The cryptographic key server as recited in claim 1, wherein said cryptographic service engine is operable to perform encryption and decryption functions.

8. The cryptographic key server as recited in claim 7, wherein said encryption and decryption functions comprise:
symmetric block ciphers;
generic cipher modes;
stream cipher modes;
public-key cryptography;
padding schemes for public-key systems;
key agreement schemes;
elliptic curve cryptography;
one-way hash functions;
message authentication codes;
cipher constructions based on hash functions;
pseudo random number generators;
password based key derivation functions;
Shamir's secret sharing scheme and Rabin's information dispersal algorithm (IDA);
DEFLATE (RFC 1951) compression/decompression with gzip (RFC 1952) and zlib (RFC 1950) format support;
fast multi-precision integer (bignum) and polynomial operations;
finite field arithmetic, including GF(p) and GF(2ⁿ); and
prime number generation and verification.

9. The cryptographic key server as recited in claim 7, wherein said encryption and decryption functions comprise:
DES, 3DES, AES, RSA, DSA, ECC, RC6, MARS, Twofish, Serpent, CAST-256, DESX, RC2, RC5, Blowfish, Diamond2, TEA, SAFER, 3-WAY, Gost, SHARK, CAST-128, Square, Shipjack, ECB, CBC, CTS, CFB, OFB, counter mode(CTR), Panama, ARC4, SEAL, WAKE, Wake-OFB, Blumblumshub, ElGamal, Nyberg-Rueppel (NR), Rabin, Rabin-Williams (RW), LUC, LUCELG, DLIES (variants of DHAES), ESIGN padding schemes for public-key systems: PKCS#1 v2.0, OAEP, PS SR, IEE P1363 EMSA2, Diffie-Hellman (DH), Unified Diffie-Hellman (DH2), Menezes-Qu-Vanstone (MQV), LUCDIF, XTR-DH, ECDSA, ECNR, ECIES, ECDH, ECMQV, SHA1, MD2, MD4, MD5, HAVAL, RIPEMD-160, Tiger, SHA-2 (SHA-256, SHA-384, and SHA-512), Panama, MD5-MAC, HMAC, XOR-MAC, CBC-MAC, DMAC, Luby-Rackoff, MDC, ANSI X9.17 appendix C, PGP's RandPool, PBKDF1 and PBKDF2 from PKCS #5.

10. The cryptographic key server as recited in claim 1, wherein said cryptographic service engine is operable to perform signing and verifying functions.

11. The cryptographic key server as recited in claim 10, wherein said signing and verifying operations includes RSA and DSA.

12. The cryptographic key server as recited in claim 1, wherein said cryptographic service engine is operable to perform hashing operations.

13. The cryptographic key server as recited in claim 10, wherein said hashing operations includes HMAC with SHA-1.

14. The cryptographic key server as recited in claim 1, wherein said cryptographic service engine is further operable to authenticate and to determine authorization of a request for cryptographic services prior to and as a condition of performing said cryptographic services.

15. The cryptographic key server as recited in claim 14, wherein authenticating a request for cryptographic services includes verifying an identity of one or more of a set comprising:
a client that is requesting for cryptographic services;
said at least one remote device from which said client requesting for cryptographic services;
a function or program that is executing on said at least one remote device.

16. The cryptographic key server as recited in claim 14, wherein determining authorization of a request for cryptographic services includes determining authorization privileges granted to one or more of a set comprising:
a client that is requesting for cryptographic services;
said at least one remote device from which said client requesting for cryptographic services;
a function or program that is executing on said at least one remote device.

17. The cryptographic key server as recited in claim 16, wherein the operation of determining authorization a request for cryptographic services further includes determining whether said request for cryptographic services is within the privileges of a requestor that is associated with said request for cryptographic services.

18. The cryptographic key server as recited in claim 1, wherein said cryptographic service engine is operable to track requests for cryptographic services.

19. The cryptographic key server as recited in claim 1, said cryptographic key server further comprising:
a private key engine, said private key engine operable to provide private keys for use by said cryptographic service engine in performing cryptographic services.

20. The cryptographic key server as recited in claim 1, wherein said cryptographic key server is a network security appliance.

21. The cryptographic key server as recited in claim 1, wherein said cryptographic key server has a computer hardware architecture supporting said cryptographic service engine and said secure network interface engine, said computer hardware architecture comprising:
a databus;
a central processing unit bi-directionally coupled to said databus;
a persistent storage device bi-directionally coupled to said databus;
a transient storage device bi-directionally coupled to said databus;
a network I/O device bi-directionally coupled to said databus;
a cryptographic accelerator card bi-directionally coupled to said databus;
a hardware security module bi-directionally coupled to said databus and suitable for storing private keys; and
a smart card interface device.

22. The cryptographic key server as recited in claim 21, wherein said hardware security module is a tamper resistant device.

23. The cryptographic key server as recited in claim 21, wherein said private keys are loaded into said hardware security module and stored in an encrypted format.

24. The cryptographic key server as recited in claim 21, wherein said private keys are loaded into said hardware security module via a smart card storing said encrypted private keys.

25. The cryptographic key server as recited in claim 24, wherein said cryptographic key server supports a k-out-of-n secret sharing such that said private keys may only be accessed by said cryptographic key server after k smart cards have been inserted.

26. A cryptographic key server suitable for providing cryptographic services to remote devices coupled to said cryptographic key server via a network, said cryptographic key server comprising:
a cryptographic accelerator card bi-directionally coupled to a databus;
a smart card interface device;
a hardware security module bi-directionally coupled to said databus and suitable for secure data; and
and wherein said secure data is accessible only when k-out-of-n smart cards are inserted into said smart card interface device.

27. An application server capable of hosting a plurality of applications, said application server operable for providing services to a plurality of clients via a network, said application server comprising:
a cryptographic application program interface (API), said cryptographic API providing a set of standards by which said plurality of applications can invoke a plurality of cryptographic services, at least one of said plurality of cryptographic services being performed by a remote cryptographic key server; and
a secure network interface engine, said secure network interface engine operable to establish a secure network communication channel with the remote cryptographic key server.

28. The application server as recited in claim 27, wherein said cryptographic API is operable to utilize said secure network interface engine to request remote cryptographic services.

29. The application server as recited in claim 27, wherein said cryptographic API is exposed as Java Cryptography Extensions (JCE) to said plurality of applications.

30. The application server as recited in claim 27, wherein said cryptographic API is exposed via Cryptographic Service Provider (CSP) and said cryptographic API is implemented as a Dynamic Linked Library.

31. The application server as recited in claim 27, wherein said cryptographic API is exposed via MS-CAPI.

32. A device capable of executing a plurality of functions and programs, said device comprising:
a secure network interface engine executing on said device, said secure network interface engine operable to establish a secure network communication channel with at least one remote cryptographic key server, marshal and transmit secure requests for cryptographic services to said at least one remote cryptographic key server, and receive and unmarshal secure responses to requests for cryptographic services; and
a cryptographic application program interface (API) executing on said device and bi-directionally coupled with said secure network interface engine, said cryptographic API providing a set of standards by which said plurality of functions and programs can call a corresponding plurality of cryptographic services, wherein at least one of said plurality of cryptographic services is performed remotely by said at least one cryptographic key server, said cryptographic API being responsive to a request for said at least one remote cryptographic service to utilize the secure network interface engine to request said cryptographic services.

33. A computer-implemented method for providing cryptographic key services, said method comprising the acts of:
establishing a set of private keys on a networked key server;
establishing a secure network communications channel between a networked device and said networked key server;
receiving a request for cryptographic key services at said networked key server from said networked device via said secure network communications channel;
authenticating said request for cryptographic key services;
determining authorization said request for cryptographic key services; and
performing said request for cryptographic key services at said networked key server utilizing said private keys when said request is authorized.

34. The computer-implemented method for providing cryptographic key services as recited in claim 33, wherein said act of establishing private keys on a networked server includes the act of encrypting said set of private keys.

35. The computer-implemented method for providing cryptographic key services as recited in claim 33, wherein said act of encrypting said set of private keys is done using a k-out-of-n secret sharing technique.

36. The computer-implemented method for providing cryptographic key services as recited in claim 33, wherein said act of establishing a secure network communications channel includes use of a SSL protocol.

37. The computer-implemented method for providing cryptographic key services as recited in claim 33, wherein said act of establishing a secure network communications channel includes use of a TLS protocol.

38. The computer-implemented method for providing cryptographic key services as recited in claim 33, wherein said act of authenticating said request includes the act of authenticating an identity of one or more of a set comprising:
a client that is requesting for cryptographic services;
said networked device from which said client is requesting for cryptographic services; and
a function or program that is executing on said networked device.

39. The computer-implemented method for providing cryptographic key services as recited in claim 33, wherein said act of determining authorization said request includes the act of determining authorization privileges granted to one or more of a set comprising:
a client that is requesting for cryptographic services;
said networked device from which said client is requesting for cryptographic services; and
a function or program that is executing on said networked device.

40. The computer-implemented method as recited in claim 38, wherein the act of determining authorization said request includes the act of determining whether said request is within rights of a requestor that is associated with said request for cryptographic services.

41. The computer-implemented method as recited in claim 33, further comprising the act of tracking all requests for cryptographic services.

42. A computer-implemented method for providing networked cryptographic key services, said method comprising the acts of:
integrating a cryptographic API within an application server;
exposing cryptographic services to a plurality of applications executing on said application server via said cryptographic API;
establishing a secure network communications channel between said application server and a remote cryptographic key server;
receiving a request for cryptographic services from an application at said cryptographic API;
marshalling said request for cryptographic services for transmission to said cryptographic key server;
transmitting said marshaled request for cryptographic services to said cryptographic key server via said secure network communications channel;
receiving a response to said request via said secure network communications channel;
unmarshalling said response; and
providing a usable response to said requesting application via said cryptographic API.

43. A method for securing cryptographic keys within a server system, the method comprising the computer-implemented acts of:
storing on a key server cryptographic keys used for encrypting data; and
wherein said key server communicates with at least one component of said server system using a secure communications channel.

44. A method for securing cryptographic keys within a network system, the method comprising the computer-implemented acts of:
storing cryptographic keys used for encrypting data on a key server, and
wherein said key server is a dedicated network appliance that performs cryptographic operations on behalf of at least one component of said network system.

45. The method as recited in claim 44, wherein said cryptographic operations include operations under a Secure Socket Layer (SSL) protocol.

46. The method as recited in claim 44, wherein said cryptographic operations include operations under a Transport Layer Security (TLS) protocol.

47. The method as recited in claim 44, wherein sensitive data is stored in said network system only in encrypted form.

48. A cryptographic key server appliance for securing cryptographic keys within a network system, wherein said cryptographic key server stores cryptographic keys and controls access to said stored cryptographic keys.

49. The cryptographic key server appliance as recited in claim 48, wherein said access includes using at least one of said stored cryptographic keys solely for encryption operations.

50. The cryptographic key server appliance as recited in claim 48, wherein said access includes using at least one of said stored cryptographic keys solely for decryption operations.

51. A cryptographic appliance for securing sensitive information within a server system, comprising:
a data communications bus;
a central processing unit bi-directionally coupled to said data communications bus;
transient memory bi-directionally coupled to said data communications bus;
persistent memory bi-directionally coupled to said data communications bus;
a network I/O device bi-directionally coupled to said data communications bus;
a crypto-accelerator unit bi-directionally coupled to said data communications bus;
a hardware security module; and
a smart card interface coupled to said data communications bus.

52. A computer-implemented method for providing cryptographic services in a network system, said computer-implemented process comprising the acts of:
securely loading cryptographic keys onto a key server;
establishing a secure transport session between a first component of said network system and said key server;
authenticating one or more components of said network including said first component to said key server;
determining authorization of said one or more components of said network including said first component to said key server;
making a request for cryptographic operations from said first component to said key server;
determining whether said request is to be performed by said key server based on results associated with the acts of authenticating and determining authorization;
if said request is authorized, then performing said requested cryptographic operations on said key server; and
providing the results of said requested cryptographic operations from said key server to said first component via said secure transport session.

53. A method for protecting data in a network system, said computer-implemented method comprising the acts of:
providing a network device for intercepting and inspecting data that is en route to an application server, wherein said network device is part of a pre-defined group of cryptographic servers that share a group key and said network device is operable for:
determining whether said data is sensitive data;
encrypting said data to form encrypted data if said data is sensitive, wherein the act of encrypting includes using a group key that is shared by said pre-defined group of cryptographic servers; and
forwarding said encrypted data to said application server;
storing said encrypted data in a storage medium associated with said application server; and
allowing one or more back-end application servers to employ one of said pre-defined group of cryptographic servers to retrieve said encrypted data from said storage medium and decrypt said encrypted data if said one or more back-end application servers is authorized to access said data.
